(19) United States
(12) Patent Application Publication
(10) Pub. No.: US 2006/0090616 A1
(43) Pub. Date: May 4, 2006

(54) Vinyl window scoring tool

(76) Inventor: Michael Gail Krause, Bangor, CA (US)

Correspondence Address: Michael G. Krause, 1721 Robinson Mill Road, Bangor, CA, 95914, US

(21) Appl. No.: 10/979,509

(22) Filed: Nov. 2, 2004

(51) Int. Cl. B26D 1/00; B26B 3/00

(52) U.S. Cl. 83/13; 30/164.9

(57) ABSTRACT

A vinyl window scoring tool useful for rapid modification to the width of various standard sizes of flat vinyl trims to a smaller chosen width. Further, the tool may be used for edge-guided scoring on either or both sides of vinyl window flush-fins. And similarly, also for edge-guided scoring parallel to existing drywall window casing and sill ends. The tool comprises a slitting-component and a scoring-component hinged together in front by a coupling pin inserted through aligned holes. Each component possesses a laterally moveable and securable blade-hold apparatus including a captured blade. An element spanning both components provides controllable pressure on the vinyl trim by the aligned blade points sandwiching the trim as it's pulled through. Removal of the coupling pin disconnects the scoring-component and permits its independent use for modification facilitated by edge-guided scoring techniques on flush-fins and drywall casings. The vinyl window scoring tool may be reassembled for use by a left handed installer.

### FEDERALLY SPONSORED RESEARCH

Not Applicable

### SEQUENCE LISTING OR PROGRAM

Not Applicable

### BACKGROUND OF THE INVENTION

There are currently numerous tools available for scoring different materials; the design differences of various tools are brought about by the individual needs of the task required, and the unique properties of the material being scored.

Numerous existing residential windows are replaced with new vinyl-frame windows. There are four different common profiles of outer perimeter-frames comprising available windows. The profiles provide an appropriate installation choice in a variety of building conditions. Installation of replacement-windows can be unpredictable and requires the means to perform various tasks on site, such as modifications to frames or window openings. Some tasks are best facilitated by scoring procedures. Removing an exact portion, or completely removing vinyl window fins is sometimes necessary on a jobsite. By removal of some or all of the fins a nail-fin perimeter-frame can be modified into a block-frame, and likewise a flush-fin frame into either a block-frame or a block-frame slope-sill style window. Reasons for such procedures vary; however, scheduled installations without negative ramifications are completed whenever possible. A specific chosen portion of a flush-fin is more often required to be removed, routinely with some types of installations.

A block-frame style perimeter-frame is made without fins and appropriate for installation within a flat opening such as brick or block. Masonry openings often include a sill that begins sloping just past the bottom exterior edge of a window frame. A new and thicker vinyl replacement-window generally extends further inward. This may create a need to cut back the casings and sill to properly locate the window relative to the exterior.

A block-frame slope-sill style perimeter-frame is similar except that it includes a fin on the bottom located flush to the exterior. This style of window typically replaces wood-sash double-hung windows. A portion of the flush-fin at the bottom must be cut to conform to the variable degree of slope on the re-utilized existing wood sill.

Windows are replaced with nail-finned vinyl windows as well for any number of reasons including planned re-stuccoing or re-siding. Nail-fin perimeter-frame windows are constructed with the fin inset from the front edge. This type of replacement-window installation requires saw cutting and removing existing siding around the opening and pulling out the nails beneath the siding. Inside the surrounding casings and window frame are separated by preferably a utility knife to avoid damage to the finished drywall casings as the window frame is removed. It's usually necessary to cut the drywall casings and sill back to accommodate the new thicker vinyl frame extending further in. It's important that the existing finished casings and sill are cut back carefully and salvaged for encasing the new frame.

Drywall window casings or sills are often cut back with utility knifes or circular saws. Many installers use a straight edge to score a target line through the hard top coating and then free hand the cut through the drywall with the utility knife. Window sizes vary prompting use of a short straight edge that may be moved to extend the score line on a longer opening. A circular saw may create a significant amount of unhealthy and unnecessary dust inside the building. Additionally they can also be dangerous and particularly upside-down sawing the top casing. Their use without precautions can further mar the textured and painted drywall, and are additionally unable to extend the saw cut into corners.

A flush-fin perimeter-frame profile includes a large fin positioned flush with the exterior window-face on all the edges. The flush-fin itself is manufactured both in a single and in a double thickness that includes a stiffener membrane in-between the plies. Vinyl flush-fin windows typically can be installed into existing window perimeter-frames without cutting stucco, siding or drywall, and without patching or painting. These types of installations occasionally require the flush-fins to be cut smaller to accommodate exterior features including applied wood trim, brick, stucco pop outs and others.

A common method of fin cutting includes use of plastic scoring tools and utility knifes on single and double walled vinyl flush-fins. The back of a fin is repeatedly scored by hand following weakened lines extruded into the back of the fin by the manufacturer. The lines are spaced about ¼ inch apart providing incremental choices for size modification. The spaced increments may require the installer to choose between a tight fit and a loose one requiring additional caulking while detracting from the appearance. A typical single-walled vinyl flush-fin height modification technique includes scoring or slitting the fin sufficiently so that the unwanted fin portion may be folded over and torn off at the folded score line. Double-walled fins are often modified in height by scoring the provided line as well. After sufficient scoring, the utility knife may be plunged through the scored line and the outside ply of the flush-fin. Using the line scored on back of the fin as a guide the utility knife can be pulled with great effort down the length of the fin. The effort slices through both layers, and has also caused serious and permanent shoulder injuries to installers. Further, even with practice the utility knife can easily get off course and slit into the window face. The same tools are used with a straightedge and this allows tighter installation tolerances than do the lines on the back. Vinyl windows are shipped standing up with thick cardboard protecting the corners at each end. This causes the center of large vinyl frame windows to sag and is straightened out during installation. Scoring the fin guided by and parallel to the edge along the length would provide the best method for a bowed frame. Another flush-fin portion-removal method includes saws using fine-toothed blades. Installers intentionally install circular saw blades backwards trying to avoid catching a tooth on the vinyl; the use of power saws on vinyl window flush-fins can easily cause fractures in frames.

An installed flush-fin vinyl window generally has a greater thickness than the original aluminum perimeter-frame it is installed within. The interior after installation reveals the original perimeter-frame and the new vinyl frame extending further inward. Foam insulation should be sprayed in the void between the two frames. Generally flat vinyl trim is permanently bonded to the new vinyl frame extending it to the casings and sill. Caulking is applied along the area the vinyl trim, sill and casings connect enclosing the original perimeter frame. Ideally all four edges of the flat vinyl trim begin equally between ¼ and ¾ inches of the daylight opening of the new frame; and leave an equal margin of the new window frame revealed beyond the trimmed area. Flat vinyl trim is available in 2¼, 2, 1¾, 1½ or 1-inch widths, and in 12-foot lengths. Windows are not always centered, and so available standard trim widths often prohibit equal margins to be presented surrounding the interior window frame. This is generally considered permissible due to the available sizes. The exact size of flat vinyl trim required is an educated guess before actual installation. This creates a necessity to stock most sizes, or to modify flat vinyl trim as needed on site. Modification to the width can be achieved by scoring vinyl trim with a straight edge and a plastic scoring tool. After scoring the trim may be folded over at the weakened scored line, and then turned over for slitting the glue and protective-wrapping with a utility knife. After slitting it's torn by hand down the folded and scored line. The method is slow and clumsy due to the nature of the long lengths of flimsy vinyl. Resizing vinyl trim widths with a table saw is feasible and most successfully accomplished when using a wooden jig to hold the thin vinyl trim down. This lessens the possibility of the trim beginning to flap while sawing, causing fractures. Table saw and circular saw use are both dangerous involving many serious injuries each year. Further, all power saws leave non-biodegradable chips of vinyl widely scattered and noise from a table saw also carries throughout an entire neighborhood.

A scoring tool specifically designed for vinyl window installation tasks has not surfaced in a search. The following are scoring and cutting tools with similarities in physical characteristics and in the manner in which they work.

U.S. Pat. No. 6,408,527 by Chubb dated Jun. 25, 2002 scores both sides of siding material concurrently with disks having an inverted V-shaped ridge. The scoring members are supported from the body by a support bar and are adjustable in relation to the body. The body portion includes a groove that receives an insert for accommodating an edge of the material targeted for scoring, other inserts are available for other corresponding thicknesses. The tool also requires a clamping device to hold the ridged material during scoring.

U.S. Pat. No. 6,334,259 by Harvey dated Jan. 1, 2002 claims an extensible and securable pivotably arranged knife holding apparatus for siding. A special guide is provided to interlock with the edge of siding allowing parallel scoring along the length of the siding.

U.S. Pat. No. 5,996,237 by Sanders dated Dec. 7, 1999, an edge cutter for a web article, has a rigid rectangular support frame including a elongate guide bar, or fence, for positioning the frame at the edge of the web article and a knife holder assembly which is transversely slidable and lockable in a selected transverse position.

U.S. Pat. No. 4,977,673 by Altizer dated Dec. 18, 1990, a cutter for a roofing sheet, has an edge guide rollers and a laterally adjustable blade, in relation to the edge guide.

The above scoring and cutting tools do not appear useful in an endeavor to fulfill the specific needs and tasks required by the window replacement industry. It is therefore an objective of the present invention to provide a single useful scoring tool more specifically designed for accommodating several tasks common to the window replacement industry. Such a tool does not to my knowledge exist today. In conclusion, the reader will see that faster safer cleaner and more accurate ways of completing the above tasks would improve several present replacement-window installation procedures.

### BRIEF SUMMARY OF THE INVENTION

The vinyl window scoring tool rapidly engages several different common replacement-window installation tasks more safely and effectively. Specifically, facilitating procedures: to modify the width of flat vinyl trim of various sizes to a smaller more useful size by use of concurrent scoring and slitting; to modify vinyl window flush-fins in height by edge guided scoring along the length at a useful chosen location on one or both sides and accordingly facilitating the removal of a specific portion; and to cut back by an edge-guided scoring procedure and re-utilize existing finished drywall window casings and sills for a replacement-window extending further inward.

The vinyl window scoring tool includes a scoring-component and slitting-component; and connected together by an inserted coupling pin hinging the front of the tool or separable by its removal. Both components include a laterally adjustable blade-hold apparatus wherein captured blade points can closely align and oppose each other. A pressure device spans both components and provides controlled and sustained pressure to be focused on the opposing blade points as they sandwich the flat vinyl trim pulled through the tool by hand. A rotating appendage and its captured machine-threaded element are fastened to the slitting-component and actuate the pressure device. The machine-threaded element may be rotated counter clockwise and captured within a slotted counterpart fastened onto the scoring-component. The elements together provide incremental adjustment of pressure on the scoring blades by use of the threads. The device compels the rear of the scoring-component and its captured blade to be controllably adjusted and secured downward while the front of the tool is hinged together. The opposing upper and lower blades simultaneously score the finished exposed side and slit the protective-wrapped adhesive underside. After one pass through the blades the trim can be easily torn into two undamaged pieces by hand along the length of the score line. This permits a new method for consistently attaining an equal margin of frame revealed surrounding the inside of a newly installed flush-fin vinyl window on a jobsite. Additionally, the tool facilitates this desirable result with only one large size of trim necessary on a jobsite while vastly cutting the need for inventory. This is especially beneficial for less popular window frame colors such as sand or almond. The tool takes seconds to adjust and prepare and is quick safe and accurate.

The vinyl window scoring tool has the additional advantage of quickly connecting or separating the two components for other individual tasks. The scoring-component can be used independently for scoring a line parallel to the edge of a vinyl window flush-fin actuating removal of a specific portion. An extendable blade-hold apparatus shaft with its captured blade may be extended away from its carriage and secured for precise modification to the fin by the scoring procedure. The carriage uses the edge of the flush-fin to guide the direction of the tool along the scoring path. Similarly, the scoring-component is further used independently for scoring existing finished drywall window casings and sills. This is desirable when necessary to cut the casings back to accommodate a new replacement window extending further inward and beneath the finished surface of re-utilized existing drywall casings.

The slitting-component includes a base plate allowing the vinyl window scoring tool to be screwed or clamped down during use. Laterally attached to the base plate are three channel-guides. Two of the guides capture a movable fence trapping flat vinyl trim between itself and the carriage, directing and aligning the trim towards the opposing blades. One channel-guide captures a securable and laterally sliding blade-hold apparatus with its captured blade for slitting the underside of the trim along the length. Also attached to the base plate is a U-channel for positioning the scoring-component's carriage partially within. A hole in both legs of the U-channel aligned with a hole in the carriage accommodates the inserted coupling pin, connecting, hinging and aligning the two components.

The scoring-component includes the carriage body permitting attachment of other elements. The securable and extendable blade-hold apparatus shaft is positioned laterally by its insertion into a hole in the carriage. The shaft positions the captured blade angled moderately rearward for a smoother scoring stroke. The slidably adjustable round shaft includes a region ground flat along its length and is secured along it by contact from an eye-bolt originating at the top of the carriage. The eye-bolt is installed tilted forward and its contact with the flat region along the shaft accordingly tilts the captured blade moderately back. Also attached to the carriage are rollers located both in front and rear of the extendable blade-hold apparatus shaft. Rollers level the carriage during use and contribute to controlling the scoring blade angle and also its depth. The rearward angle of the blade lessens the tendency to catch on penetrated vinyl window material allowing for a smoother forward scoring-stroke during use. The area of the carriage below its rollers serves as an edge-guide or fixed position fence for all of the tools intended tasks. A cutout in the rear of the carriage creates a pistol grip handle used in individual scoring-component tasks.

The vinyl window scoring tool is a safe, portable and dependable multiple-use tool designed for the window replacement industry. Accordingly, several objects and advantages of the vinyl window scoring tool are:

[a] to provide a method whereby equally margined interior portions of vinyl window frame reveals are practical and achievable by enabling widths of flat vinyl trim to be quickly, safely and accurately resized to a smaller chosen width by an installer in the field;

[b] to provide a means of reducing the amount of flat vinyl trim sizes necessary in an inventory and still permitting a more esthetically pleasing finished product;

[c] to provide an edge-guided method of scoring on either or both sides of single or double walled vinyl window flush-fins parallel to the outer edge quickly and accurately;

[d] to provide an edge-guided method of quickly and accurately scoring a straight line on existing finished drywall window casings and sills parallel to exposed drywall ends;

[e] a tool which requires no precautions or additional measures to avoid damage to flat vinyl trim, vinyl window frames, or drywall casings and sills during use;

[f] a tool that provides a great deal of additional safety to commonly necessary tasks;

[g] a tool that may be reassembled for use by a left handed installer;

[h] a tool that can not score past its targeted line and into an exposed surface during any intended scoring procedure;

[i] a scoring tool that routinely follows a pre-installation bow in large vinyl window frames;

[j] an edge-guided tool which allows the scoring process to be constantly visually monitored;

[k] a tool that is manually operated and environmentally friendly, with little noise or mess;

[l] a durable tool needing little care or maintenance;

[m] a tool that needs no special knowledge to operate;

[n] a vinyl scoring tool without tendency to snag on penetrated vinyl comprising window frames;

[o] a vinyl window scoring tool that takes seconds to prepare or adjust for any of its intended uses.

Still further objects and advantages will become apparent from the ensuing description and drawings.

### BRIEF DESCRIPTION OF DRAWINGS

In the drawings the vinyl window scoring tool is illustrated assembled for use by a right handed installer.

FIG. [1] shows vinyl window scoring tool

FIG. [2] shows slitting-component separated

FIG. [3] shows scoring-component separated

FIG. [4] shows scoring-component separated scoring a vinyl window flush-fin [top view]

FIG. [5] shows vinyl window scoring tool loaded with flat vinyl trim to modify

### REFERENCE NUMERALS

[18] blade, included in the slitting-component slidable blade-hold apparatus
[19] blade, included in the scoring component extendable blade-hold apparatus
[20] base plate, a securable platform for attachment of additional elements comprising the slitting-component
[22] U-channel, occupied by the carriage and serving as a table for vinyl trim
[23] channel-guide, number one at rear base plate and capturing the slidable blade-hold apparatus
[24] channel-guide, number two cooperating to capture and control movable fence assembly
[25] channel-guide, number three cooperating to capture and control movable fence assembly
[26] coupling pin, attaches and aligns the two components hinging the scoring tool
[28] carriage, a frame and body for the scoring-component
[30] holes for coupling pin, through the U-channel
[31] hole for coupling pin, in the carriage
[32] connecter bolt, attaches to and extends from U-channel, and is rotatable
[34] movable fence assembly, traps and aligns various widths of vinyl trim against the carriage
[36] thumb turns with flanged nuts, for securing the moveable fence
[38] eye-bolt with flanged nut lodged at top, threaded through the rotatable connecter bolt
[40] fork assembly, attaches to carriage for capturing the eye-bolt providing scoring pressure
[42] extendable blade-hold apparatus shaft, securable and slidable within hole through carriage
[44] slidable blade-hold apparatus bar, captured within the rearward most channel-guide
[46] eye-bolt, for securing slidable blade-hold apparatus bar position within the channel-guide
[48] tilted eye-bolt, for securing the extendable blade-hold apparatus shaft position and angle
[50] cross dowel, threaded through by the tilted eye-bolt securing extendable blade-hold shaft
[52] roller assemblies, one of four and identical attached to the carriage
[54] joint connecter nuts, for attaching the roller assemblies, channel-guides and U-channel
[56] handle cutout, forming a useable handle from the rear portion of the carriage
[58] exterior side of vinyl flush-fin window depicted as it would be scored
[60] a line scored by the separated scoring-component on a flush-fin
[62] flat vinyl trim typically used to finish the interior around a newly installed flush-fin window

### DETAILED DESCRIPTION OF THE INVENTION

An embodiment of the vinyl window scoring tool as well as aspects of construction and operation are here described.

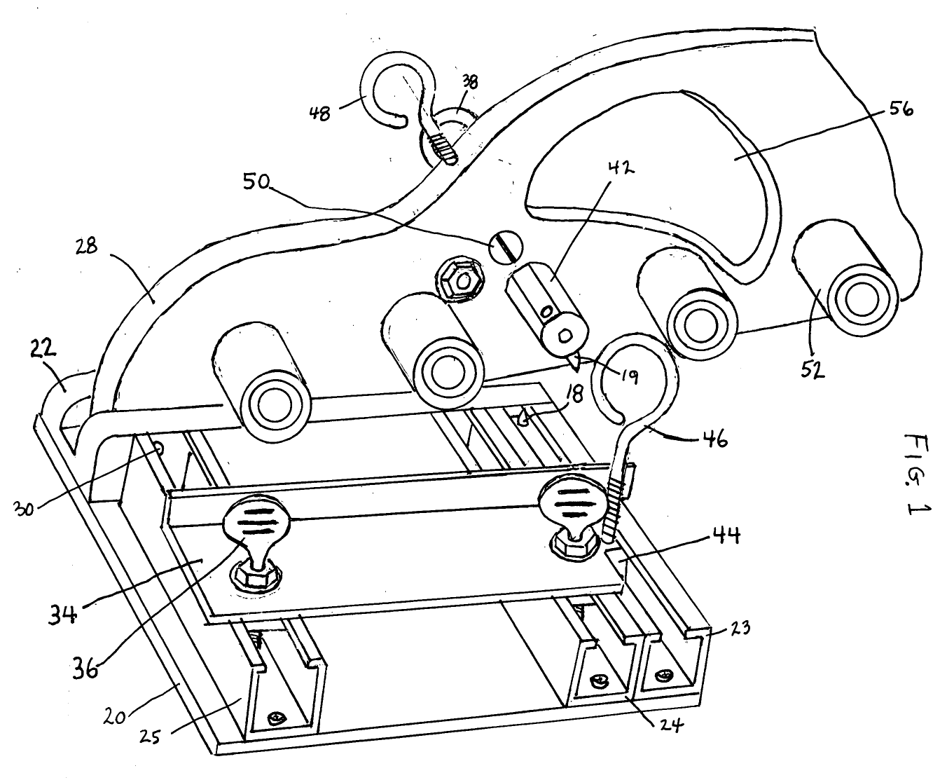

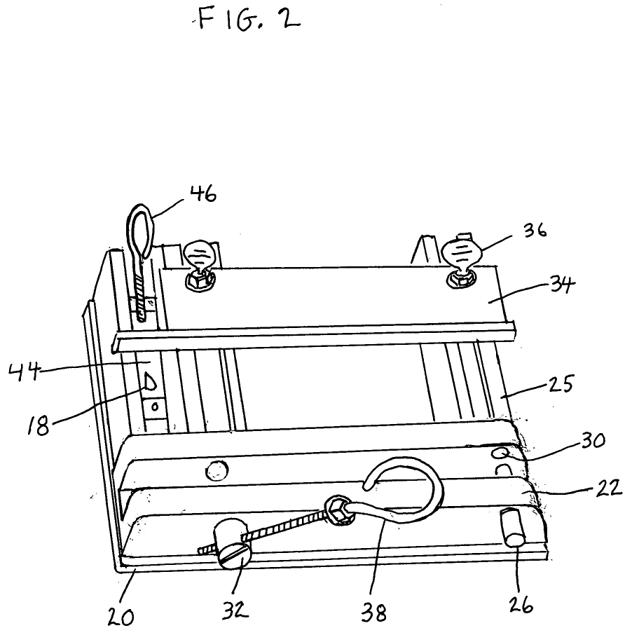

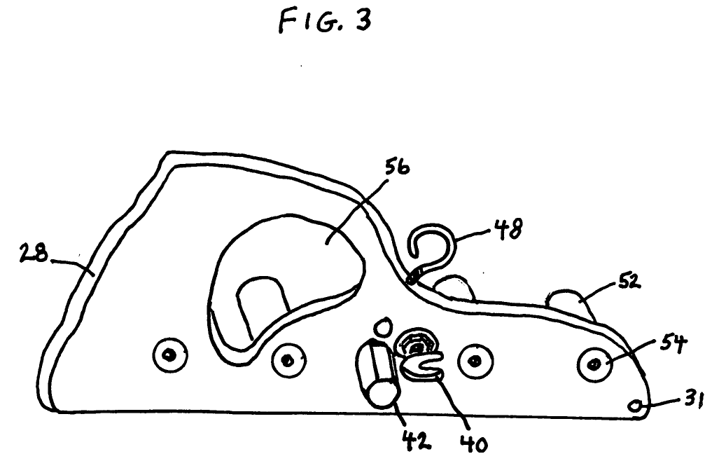

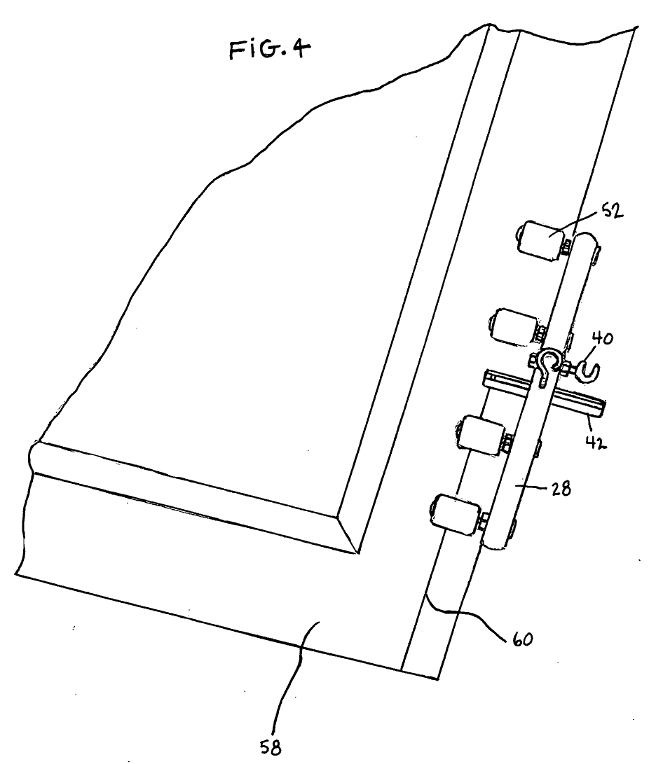

The vinyl window scoring tool illustrated in FIG. 1 includes two components defined individually as a slitting-component illustrated in FIG. 2, and a scoring-component illustrated in FIG. 3. The two components are used combined to modify the width of flat vinyl trim by concurrently scoring the top and slitting the protective-wrapped self-adhesive bottom. The scoring-component is detachable by pulling out a coupling pin 26 and can then be used individually for edge-guided scoring on vinyl window flush-fins as illustrated in FIG. 4. Additionally, the scoring-component can be used similarly for edge-guided scoring along exposed ends of finished drywall casings surrounding interior window openings.

The slitting-component seen in FIG. 2 includes a base plate 20 of flat polycarbide sheet or aluminum plate. The base plate includes holes with corresponding holes in the bottoms of a U-channel 22 and three channel-guides 23, 24, 25 for attachment by machine screws threaded into joint connecter, or T nuts. The tops of the U-channel and channel-guides are equal in height; and in collaboration with rollers 52 capture flat vinyl trim and position it between a moveable fence assembly 34 and carriage 28. This creates alignment for various widths of flat vinyl trim pulled through the tool towards aligned opposing blades.

The three channel-guides are square and hollow extrusions with slots cut lengthways along the tops. The channel-guides are attached positioned laterally with one end against the inside leg the U-channel 22 and the opposite end terminating at the outside edge of the base plate 20. Raised heads on screws contain the slidable elements within the channel-guides on the open end. Counter sunken flat-head screws at the opposing end permit elements within the channel-guides to slide over unimpeded. The first and second channel-guides 23, 24 are positioned side by side with the first 23 located at the rear of the base plate 20. The third channel-guide 25 is positioned near the front of the base plate. The first channel-guide contains a slidable blade-hold apparatus bar 44 including its captured blade 18. The second and third channel-guides capture and control the securable and laterally moveable fence assembly 34. The slots in the channel-guides allow the blade 18 and eye-bolt 46 to extend above the slot; and also permit the thumb turns 36 securing the moveable fence access to thread into square nuts slidable within the channel-guides.

The U-channel 22 is an extrusion the length of the base plate 20 attached near the edge. It includes a wall thickness sufficient to drill, tap and rotatably mount a coarsely threaded connecter bolt 32 on the outside leg. The inside leg is drilled and tapped as well for reversibility of the tool accommodating a left-handed installer. A hole through the side of both legs of the U-channel near the top-front aligns with a single hole in the bottom-front of the scoring-component carriage 28 positioned within the U-channel. Insertion of the coupling pin 26 through the aligned holes connects the two components. Separating the two components is managed by removal of the coupling pin. Hinged by the coupling pin 26, the lower portion of the carriage 28 is positioned above the bottom within the U-channel. It is suitably located to hinge at the front of the tool and allows vinyl trim between the two connected components.

A securable and laterally slidable blade-hold apparatus includes a stainless steel bar 44 slidable within the rear channel-guide 23. A hole is located at one end of the bar for inserting the blade 18; and the blade secured there by a setscrew within an intersecting threaded hole from the end of the bar. The opposite end of the bar includes a hole for threaded insertion through the channel-guide slot of eye-bolt 46 to secure the bar. Accordingly, the blade may be positioned at a useful location along the slot in the channel-guide for modifying the width of flat vinyl trim. The slot in the channel-guide permits the eye-bolt 46 and the blade 18 to project above the slot and allows each to be accessible. The length of the bar 44 allows the blade 18 to be located without interference from the moveable fence 34. Performing as a thumb turn with additional leverage the eye-bolt 46 is tightened forcing the bar upward and locking the lateral position within the channel-guide.

The moveable fence assembly 34 is positioned on top of and controlled by the two forward channel-guides 24 and 25. It is laterally slidable and securable and preferably includes an L-shaped extrusion. Two holes in the extrusion located directly over the slots in the channel-guides snugly permit insertion of threaded thumb-turns that include flanged nuts lodged at the tops of the threads used as stops. The threaded shafts continue through the slots into square nuts slidably captured within the channel-guides. As the thumb turns are tightened the flanged stop-nuts bottom out on the L shaped extrusion. This causes the square nuts to rise and lock within the channel-guides securing the position of the moveable fence assembly. The movable fence end atop channel-guide 23 containing the slidable bar 44 is notched to avoid interference with the eye-bolt 46. The moveable fence and the lower portion of the carriage 28 co-operate to trap and align standard widths of flat vinyl trim pulled through the opposing blades.

Elements of a device to provide scoring pressure span both the scoring and the slitting components. Engagement pushes the rear of the scoring-component downward sandwiching the flat vinyl trim between opposing blades in both components. The device includes the coarsely threaded connecter bolt 32 mounted in the outside leg of the U-channel 22 and positioned to mesh with other existing vinyl window scoring tool elements present. Threaded through the diameter of the connecter-bolt is an eye-bolt with a flanged nut 38 lodged at the top of its threads. Rotating by means of the connecter bolt threads, the eye-bolt 38 shaft swings counter clockwise and is captured within a slot on a fork 40 assembly attached to the scoring-component carriage. The fork is an attached element with a forward facing slot for capturing the eye-bolt 38. Tightening the eye-bolt with the flanged nut topping the fork forces the scoring-component carriage 28 downward. Two serrated nuts on the forks threaded shaft sandwich the carriage and secure it slightly above and in between the holes for shaft 42 and the next forward roller. Connecter bolt 32 is located directly below the slot in the fork for an aligned connection.

The identical blades are preferably fashioned from ⅛×¼×⅞ inch carbide suitable for machine tooling bits. Viewed from the flat front ⅛-inch wide and longest edge, they are ground into inverted V-shapes ending with sharp points. The blades slant back from the points and the sides are tapered, thinning and sharp on the rear edges. Within the scoring-component its blade is positioned moderately tilted rearward and using the flat front V-shaped edge for scoring. The slitting-component blade is rotated 180 degrees using the sharp knife-like edge for slitting the protective-wrapped self-adhesive side of flat vinyl trim.

The scoring-component seen in FIG. 3 includes the carriage 28 shaped from polycarbonate sheet or aluminum plate. The carriage serves as a body and an edge-guide for all the scoring tool intended tasks. Holes in the carriage are used for attaching an extendable blade-hold apparatus shaft 42; four roller assemblies 52; the fork assembly 40; a hole for the coupling pin 26 and a hole for a cross dowel 50. Further included is a moderately tilting hole for accepting eye-bolt 48. The hole begins forward of the shaft 42 and on top of the carriage. It angles downward intersecting the hole for the cross dowel 50 and continuing into the top of the central hole mounting the extendable blade-hold apparatus shaft 42. The rear portion of the carriage includes a handle cut out 56 serving during individual-use scoring-component tasks. It is positioned above and in between the two rear rollers for user comfort, control and safety.

The extendable blade-hold apparatus includes a cylindrical length of preferably hardened stainless steel for the shaft 42, with a captured blade 19 included near the end. The shaft includes a flat region along the length and is penetrated by a hole near the end centered in the flat region and through the diameter of the shaft for inserting the blade. The same end of the shaft has an intersecting hole from the end for a setscrew to secure the inserted blade, further allowing adjustment in the blade 19 height. Eye-bolt 48 is inserted in the vertically tilted hole from the top of the carriage 28 and is threaded through the cross dowel 50 and continues on intersecting the central hole containing the shaft 42. The flat threaded end of tilted eye-bolt 48 contacts the flat area along the inserted shaft 42; securing both the moderately tilted back angle of the blade and further allowing the shaft its securable extendibility. The rearward tilt in the blade permits smoother forward scoring strokes lessening the tendency to catch in partially penetrated vinyl window material. The length of the shaft permits the captured blade within it to be extended from the carriage to reach desirable locations on flat vinyl trim, flush-fins or interior drywall window casings. The shaft is located slightly above the rollers for clearance and with the captured blade point set approximately ⅛ inch below the rollers for all intended tasks.

All four identical roller assemblies 52 include an axel-bolt inserted through a washer, a roller bearing covered with non-scuffing rubber-like hose, another washer, threaded through a flanged nut and lastly threaded into a joint connecter nut 54 inserted into the hole in the carriage 28 from the opposite side. The two nuts tightly sandwich the carriage and secure the roller. The roller assemblies are installed two forward and two rearward of the central hole in the carriage for the shaft 42. The two rollers straddling the shaft are spread out to allow constant visual monitoring of the scoring process during use. The four rollers co-operate with the shaft 42 in keeping the blade 19 at the preferred scoring angle by leveling the carriage during individual-use scoring-component tasks. The rollers are of a length to avoid interference with any part of a typical vinyl window flush-fin frame on the front or back while scoring it. The tool can be re-assembled to a mirror image for accommodating left-handed window installers.

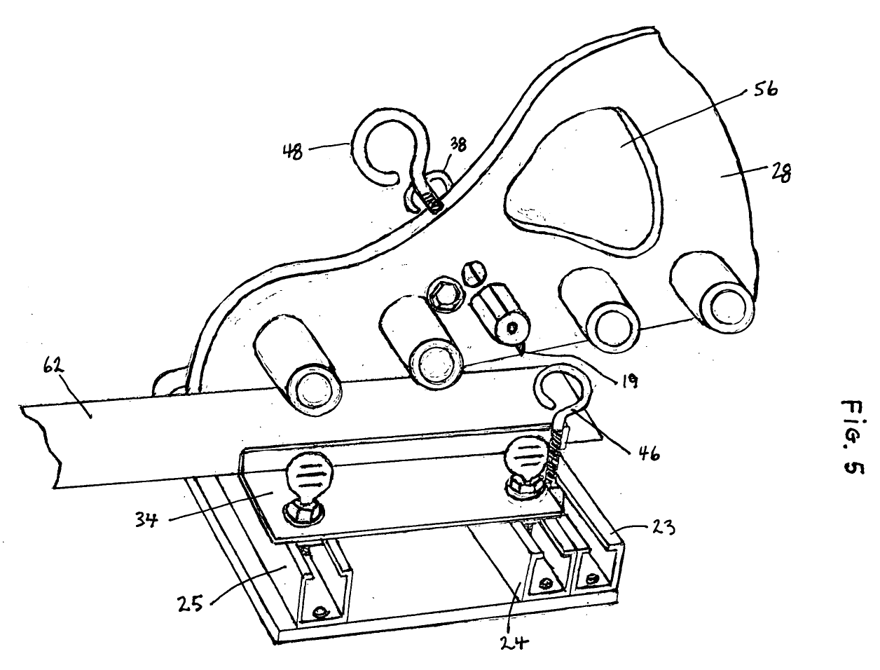

In operation the vinyl window scoring tool is used for concurrently scoring and slitting flat vinyl trim to modify the width and is illustrated prepared to do so in FIG. 5. The moveable fence 34 traps and aligns flat vinyl trim 62 of various widths moving through upper and lower blade points 18, 19 sandwiching the trim. Concurrently, controlled and sustained pressure can be mechanically applied by machine threads squeezing the aligned blade points together extended outward a chosen and matching distance from the carriage 28. Flat vinyl trim 62 pulled through the tool may be easily torn in two along the aligned score lines.

The base plate 20 of the slitting-component seen in FIG. 2 can be secured with a clamp, screws or bolts to a bench, tailgate or another fixed object. Trim alteration requires room for the flexible vinyl trim to be fed in the front and pulled out through the back. To alter the width of flat vinyl trim the two components are used coupled together. Place the carriage of the scoring-component into the U-channel of the slitting-component and line up the two provided holes 30 in the U-channel with the single hole in the carriage 28. Insert the coupling pin 26, connecting hinging and aligning the two components together. This allows hinged downward motion of the rear of the carriage and thus pinches the aligned flat vinyl trim between the opposing blade points as it's pulled through. The flat trim should be fed into the front of the tool; and with the adhesive side face down and from either end of the trim the target is laterally reachable by the opposing blades. Move the sliding blade-hold apparatus bar 44 to locate the blade point to the targeted distance from the carriage 28 and secure eye-bolt 46. Locate the extendable blade-hold apparatus shaft 42 in the scoring-component to position the blade a matching distance from the carriage, aligning the opposing blades over one another. Feed the trim through from the front stopping just past the rear blade at a point the trim can be grabbed by pliers. Lightly pinch the vinyl trim between the carriage and the movable fence 34 and secure the thumb turns 36. Apply blade point pressure by rotating the eyebolt and flanged nut 38 into the slot on the fork with the flanged nut topping it. Tighten the eye-bolt 38 to compel the sharp points of both blades to sink into the soft vinyl trim. At the point the trim may be pulled through and still sufficiently scored and slit, grasp the end with pliers to start it and pull it completely through. The furrow scored in the top by the scoring-component blade and the aligned slit cut in the underside should be sufficient for actuating width modification of vinyl trim in one pass. Fold the trim over on the score line at the end last scored to start a fracture and tear along the length into two undamaged pieces. Rotate the eye-bolt and flanged nut 38 forward off the top of the fork. Raise the rear of the tool slightly and rotate the eye-bolt back into the slotted fork with the flanged nut under the slot. This leaves the tool open to provide access for the next piece of trim to be pulled through.

The scoring-component may be uncoupled, lifted out of the slitting-component and used independently for scoring vinyl window flush-fins as illustrated in FIG. 4, or drywall window casings in a similar fashion. This function allows the flush-fins to be scored guided by the edge at a chosen location parallel to the fins edge. This may be preformed on the front, the back, or both sides improving the scoring process by facilitating the accurate and rapid removal of a chosen portion of fin. Another independent function of the scoring-component includes scoring a line on finished interior drywall casings and sills parallel with, and guided by the drywall ends.

To score vinyl window flush-fins remove the scoring-component by pulling out the coupling pin 26. Make a pencil mark on targeted material representing the amount to be removed from the edge of the window fin. The window may be scored as it's standing up or lying prone. Loosen the tilted eye-bolt 48 securing the extendable shaft 42 and locate the scoring blade point over the mark with the carriage contacting the outer fin edge and secure eye-bolt 48. Grip the handle from the rear with three fingers and the thumb, and the index finger outside the cutout 56 pointing in the direction to be scored. Place the carriage contacting the outer edge of the window fin. Place the scoring blade point just inside the adjoining edge of the fin with the front wheels lined up on the target in the desired direction. Push the tool forward as illustrated in FIG. 4 with slight downward and inward pressure, scoring a deep line the length of the window fin with the carriage in constant contact with the outer edge of the fin. Repeat the scoring action as necessary. Double walled fin scoring may be repeated on the opposite side as well. A utility knife can then more easily slit through any remaining vinyl and the stiffener membrane between the double wall vinyl plies. A single walled vinyl fin scoring procedure is similar; however, after suitable scoring the corner welds near the ends are cut and the fin is folded over at the score line and torn off.

Using the tool for actuating complete removal of double walled flush fins is accomplished by using the tool much as one would to score a flush-fin on its outside. An advantage of using the tool for this procedure is that it will follow a bow in a large window and score a line parallel to the bowed edge. The bow in the window will be removed during installation. After scoring the outside sufficiently, the window may be scored on the inside with a plastic scoring tool or utility knife using the window body as a guide.

The tool may be further engaged for edge-guided scoring on drywall window casings when cutting them back to accommodate installation of a new and thicker vinyl window. The objective is to score through the drywall topcoat and to create a clean straight line of cut drywall edge for the new window frame to but up against; and be hidden by a small caulking bead seamlessly connecting the two. Set the extendable blade-hold apparatus bar 42 to align the blade with the desired position and secure with the tilted eye-bolt 48. The drywall ends are straight; they butted up to the previously removed window frame and now serve to guide the carriage. Score through the texture coat as far into the corners as possible and extend the score line by use of the utility knife to the unreachable areas in each corner. Plunge the utility knife through the scored line and cut the drywall using the scored line as a guide. Remove the drywall pieces to allow installation of the new window.

Although the description above contains much specificity this should not be construed as limiting the scope of the invention, but merely providing illustrations of its intended capabilities and uses. Thus the scope of the invention should be determined by the appended claims and their legal equivalents, rather than by the examples given.

This is what is claimed:

1. A multiple use vinyl window scoring tool actuating edge guided scoring procedures to remove selected parallel portions by concurrently scoring and slitting flat vinyl trim and scoring vinyl window flush-fins or drywall casings and sills with said scoring tool comprising;
[a] a slitting-component and a scoring-component; and
[b] said slitting-component and said scoring-component further including a means of separating or connecting hinging and aligning the two said components; and
[c] said slitting-component and said scoring-component further include in each a blade-hold apparatus laterally movable from opposing directions; and
[d] each said blade-hold apparatus further includes a means to position a captured blade in each component to align closely opposing one another; and
[e] a means of providing adjustable scoring pressure spanning said slitting-component and said scoring-component wherein its engagement applies controlled and sustained pressure by said opposing captured blade points sandwiching said flat vinyl trim pulled through said vinyl window scoring tool by hand; and
[f] a means to trap and align various standard widths of said flat vinyl trim pulled through said captured blades.

2. Said slitting-component according to claim 1 further including a base plate.

3. Said base plate of claim 2 further including a securable and laterally slidable blade-hold apparatus.

4. Said blade-hold apparatus according to claim 3 further including a V-shaped sharply pointed scoring blade progressively thinning back and sharp on the sloping rear edge.

5. Said slitting-component according to claim 2 further including a securable and laterally moveable fence assembly.

6. Said slitting-component according to claim 5 further including a coupling pin.

7. Said slitting-component according to claim 6 further including a rotating appendage including a threaded hole through the diameter containing a corresponding threaded element suitable to engage a counter part affixed to said scoring-component.

8. Said scoring-component according to claim 7 further includes a carriage.

9. Said carriage according to claim 8 further including an attached fork element suitable to be engaged by said threaded element contained by said rotating appendage.

10. Said scoring-component according to claim 9 further including a securable and laterally extendable blade-hold apparatus.

11. Said scoring-component according to claim 10 further including a friction reducing means of controlling said captured blade angle and depth and trapping flat vinyl trim.

12. Said carriage according to claim 8 further including a cut out forming a suitable handle.

13. Said scoring tool according to claim 1 further permitting mirror-image reassembly for use by left handed installers.

14. A method of concurrently scoring and slitting along the lengths of various widths of said flat vinyl trim for modifying the width to a smaller chosen size and with said method comprising of;
providing a scoring tool;
making a lateral adjustment of said slidable blade-hold apparatus and said extendable blade-hold apparatus wherein said blades are aligned over each other and secured at a chosen location outward from said carriage relating to a chosen targeted mark on said flat vinyl trim;
positioning said flat vinyl trim into said scoring tool from the front past said blades and stopping minimally past the rear of said vinyl window scoring tool to a point said vinyl trim can be grasped;
adjusting and securing said movable fence slidably capturing said flat vinyl trim between said carriage and said movable fence;
engaging said scoring pressure device by rotating the machine threaded eye-bolt into the fork;
adjusting the amount of scoring pressure by tightening the eye-bolt to a sufficient level for ample said concurrent scoring and slitting in a single pass through said vinyl window scoring tool;
pulling said flat vinyl trim completely through thus concurrently scoring and slitting from above and below;
bending said flat vinyl trim at the end of the scored and slit line to start a fracture and to then tear along said scored and slit line into two pieces.

15. A method of scoring a vinyl window flush-fin and facilitating an alteration to said flush-fin height by removal of a parallel portion along the length with said method comprising;
providing a scoring tool;
pulling out said coupling pin and removing said scoring-component from said slitting-component;
calculating an amount of flush-fin requiring removal along the length and make a corresponding mark on said flush-fin;
with said carriage contacting said flush-fin edge adjust said extendable blade-hold apparatus and thus its blade point to be aligned with said mark on said flush-fin representing the unwanted portion to be removed and secure said blade-hold apparatus with provided means;
place said carriage fence area aligned and in contact with the edge of said flush-fin targeted for scoring and with the point of said blade immediately inside the adjacent edge at corner;
grasping said handle and pushing forward and thus scoring a parallel line along the face or back of the said flush-fin with continuous aligned contact between said carriage and the edge;
repeat the scoring process as necessary;
finish double walled vinyl flush-fin separation process with a utility knife or a suitable substitute; and
finish single walled flush-fin modification process by bending said fin at the scored line starting a fracture and tearing off the excess portion of said fin by hand.

16. A method of scoring for removing a portion of existing finished drywall parallel to the exposed drywall ends comprising the casings and sill and towards the interior for accommodating installation of a new and thicker window frame extending further towards the interior and with said method comprising;
providing a scoring tool;
calculate an amount of finished existing drywall that need be removed to accommodate a new and thicker window extending further towards interior and placing a mark on said drywall at the point representing the amount of drywall chosen for removal;
extend said scoring-component extendable blade-hold apparatus and thus said blade and secure said blade point on said mark on said drywall with said carriage aligned and in contact with exposed drywall ends formerly in contact with the inside of the previous window frame;
push said scoring-component forward and use provided handle to control scoring through said drywall top coat on all sides within the opening and with said carriage in constant contact with said drywall ends;
follow the scored line with a utility knife and slit through remaining said drywall and into the corners and then remove the excess drywall having been separated by said method.
